(19) United States
(12) Patent Application Publication
(10) Pub. No.: US 2021/0060543 A1
(43) Pub. Date: Mar. 4, 2021

(54) DILUTION DISPENSING

(71) Applicant: HEWLETT-PACKARD DEVELOPMENT COMPANY, L.P., Spring, TX (US)

(72) Inventors: David OCHS, Corvallis, OR (US); Kenneth WARD, Corvallis, OR (US)

(21) Appl. No.: 16/605,945

(22) PCT Filed: Sep. 27, 2017
(86) PCT No.: PCT/US2017/053805

§ 371 Date: Oct. 17, 2019

(51) Int. Cl. B01L 3/02

(52) U.S. Cl. CPC B01L 3/0293; B01L 3/0286; B01L 2300/0829; B01L 2200/0642; B01L 2200/0605

(57) ABSTRACT

Examples disclosed herein relate to a device. Examples to determine a dispense routine for a default dilution of a compound according to a dispense request identifying a second dilution of the compound, and a dispense engine to control the dispense device to dispense at least a portion of the default dilution of the compound according to the dispense routine. In examples, the dilution engine is to determine the dispense routine by comparing the second dilution to the default dilution to determine whether the default dilution is dilutable to the second dilution.

### BACKGROUND

Laboratories often run experiments using various different liquids to obtain different types of experimental data. The experiments may use fluid dispense device that dispense fluid into well plate(s) to perform the various different experiments.

### BRIEF DESCRIPTION OF THE DRAWINGS

The following detailed description references the drawings, wherein:

FIG. 1 is a block diagram of an example device;

FIG. 2 is a block diagram of an example device;

FIG. 3 is a flowchart of an example process;

FIG. 4 is a flowchart of an example processes which may be incorporated into the flowchart of FIG. 3; and

FIG. 5 is a block diagram of an example device to dispense a dilution.

Throughout the drawings, identical reference numbers designate similar, but not necessarily identical, elements. The figures are not necessarily to scale, and the size of some parts may be exaggerated to more clearly illustrate the example shown. Moreover the drawings provide examples and/or implementations consistent with the description; however, the description is not limited to the examples and/or implementations provided in the drawings.

### DETAILED DESCRIPTION

Fluid dispense devices may dispense compounds into a well plate. Fluid dispense devices may receive a dispense request to control which compounds are dispensed in which location or well of a well plate to generate specific compound concentrations or dilutions in the well plate. In some examples, a dilution of a compound may be used to generate a specific concentration of a compound. However, not all dilutions are easy to create and the user may have a pre-existing dilutions or easy to create dilutions which may be used for some experiments.

In examples and throughout the specification, a “well plate” refers to a physical structure to house compound(s), which are also referred to as “wells.” In some examples, a well plate may include a commercially available plate with a plurality of wells (e.g., a 384 well plate, a 1534 well plate, etc.), a polymeric sheet with pockets formed therein, a lab-on-chip device, a slide, a material to receive a compound(s) (e.g., a porous material), or any other type of structure to receive compound(s). In contrast, a “well” refers to a single physical structure or location on a material to receive a compound(s). In examples, a well may be a single well of a commercially available well plate, a single pocket in a polymeric sheet, a single region of a lab-on chip-device, and a single region of a material. In some examples, a lab-on-chip device may include channels and/or chambers which may act as a well. In some examples, a material may be a porous material with regions which may act as a well.

Moreover, as used herein, a “compound” refers to a powder or fluid to be dispensed by a fluid dispense device. In some examples, compounds may be fluids such as aqueous based compounds, aqueous based compounds with surfactants or glycerol added therein, dimethyl sulfoxide (DMSO) based compounds, mixture of compounds (e.g., a master mix), and the like. In other examples, compound may be fluids including nanoparticles, small molecules, or biomolecules (i.e. proteins, enzymes, lipids, antibiotics, DNA samples, cells, or blood components, etc.) added to a base fluid. In yet other examples, a compound may be a solid such as a powder of metals, ceramics, or composites to be dispensed by a dispense device.

Furthermore, as used herein, a “dispense request” is a request received by a device to dispense a compound(s) into a particular well. A dispense request may include a request for a concentration or dilution of the compound to be ejected/dispensed. As user herein, a “dispense routine” refers to instructions to actuate a fluid dispense device to eject/dispense a compound.

To address the issues described herein, in examples, a device is described in which a default dilution of a first compound may be selected to perform dispense routines in a fluid dispense device. In examples, the dispense routine may be based at least in part on a dispense request identifying a second dilution of the first compound. In some examples, the default dilution may be one of many dilutions of the first compound available for ejecting/dispensing. In examples, the device may determine the dispense routine by comparing the second dilution to the first dilution to determine whether the first dilution may be dilutable to the second dilution.

As shown herein, example devices may comprise engines, where such engines may be any combination of hardware and programming to implement the functionalities of the respective engines. In some examples described herein, the combinations of hardware and programming may be implemented in a number of different ways. For example, the programming for the engines may be processor executable instructions stored on a non-transitory machine-readable storage medium and the hardware for the engines may include a processing resource to process and execute those instructions. A “processor” may be at least one of a central processing unit (CPU), a semiconductor-based microprocessor, a graphics processing unit (GPU), a field-programmable gate array (FPGA) to retrieve and execute instructions, other electronic circuitry suitable for the retrieval and execution of instructions stored on a machine-readable storage medium, or a combination thereof.

In some examples, a device implementing such engines may include the machine-readable storage medium storing the instructions and the processing resource to process the instructions, or the machine-readable storage medium may be separately stored and accessible by the system and the processing resource. In some examples, engines may be implemented in circuitry. Moreover, processing resources used to implement engines may comprise a processor (e.g., a CPU), an application specific integrated circuit (ASIC), a specialized controller, and/or other such types of logical components that may be implemented for data processing.

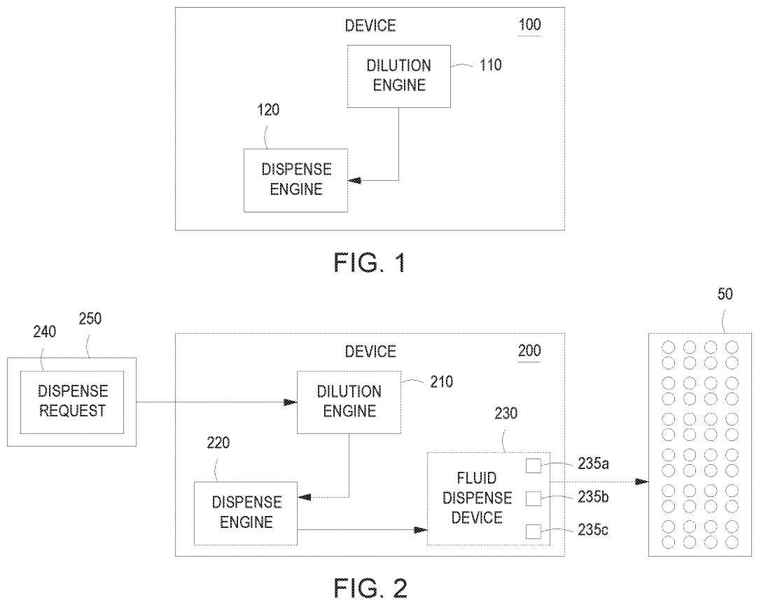

Turning now to the figures, and particularly to FIG. 1, this figure provides a block diagram that illustrates some components of an example device 100. Example device 100 may include a dilution engine 110 and a dispense engine 120.

In some examples, device 100 may be a device to control the ejection of compound(s). In some examples, device 100 may control ejection of compound(s) by a fluid dispense device to dispense or eject compound(s). Example fluid dispense devices may include digital titration devices, pharmaceutical dispensation devices, lab-on-chip devices, fluidic diagnostic circuits, drop-based ejection devices (e.g., a printhead), 3D printing devices, and/or other such devices in which amounts of compounds may be dispensed or ejected.

In examples, dilution engine 110 may determine a dispense routine for a default dilution of a compound according to a dispense request identifying a second dilution of the compound. In examples, dilution engine 110 may determine the dispense routine by comparing the second dilution to the default dilution to determine whether the default dilution is dilutable to the second dilution. In examples, the default dilution may be identified by a user in device 100. In some examples, the default dilution may be one of a plurality of dilutions available to the fluid dispense device for dispensing/ejecting. For example, a default dilution may be chosen from among two dilutions of a compound available to the fluid dispense device.

In operation, in an example, device 100 may receive a dispense request identifying a dilution of a compound to be dispensed. In such an example, device 100 may determine whether any dilution of the compound may be available to device 100 to perform the dispense request. In an example, device 100 may determine none of the dilutions of the compound available to device 100 may be used for the dispense request. In such an example, device 100 may determine a second dilution of the compound to be used to perform the dispense request. In such an example, device 100 may request a user provide the second dilution for dispensing via, for example, a display coupled to device 100. In examples, the display may display a graphical user interface (GUI). In examples, the GUI may display prompts, information, current progress of device 100, current progress of an experimental recipe (e.g., a program that is executed by the fluid dispense device which may specify which compounds are to be dispensed into which wells of the well plate, at which times the compounds may be dispensed, an amount of each compound that may be dispensed into each well, and the like) that is being executed, collect user provided data, and the like. In some example, device 100 may receive a default dilution request identifying a default dilution to use for the dispense request.

In operation, in another example, device 100 may provide a prompt for a user to identify a default dilution(s) for compound(s) to be used via, for example, the GUI. In some examples, the default dilution may be a plurality of dilutions. For example, the default dilution may identify two dilutions of a compound to be used in a dispense routine. In one such example, the default dilution request may identify one of the default dilutions to prioritize over other default dilutions.

In examples, device 100 may passively acquire (i.e., receive) or actively acquire (i.e., retrieve) the dispense request. In examples, a dispense request may be a request to dispense compound(s) from the fluid dispense device. In examples, the dispense request may specify a dilution of a compound to be dispensed. For example, the dispense request may specify to dispense a 1:6 dilution of compound A to compound B in well of a well plate. In another example, the dispense request may specify to dispense a 1:100 dilution of compound A. In examples, dilution engine 110 may determine a dispense routine to be performed to reach the dilution specified in the dispense request. For example, to dispense a 1:6 dilution of compound A to compound B into a well of a well plate, dilution engine 110 may determine as a dispense routine a volume of compound A to dispense compared to a volume of compound B to dispense according to a variety of factors. In another example, to dispense a 1:100 dilution of compound A into a well plate, dilution engine 110 may determine a volume of compound A to dispense according to a variety of factors. In examples, the variety of factors to determine the dispense routine may be a volume of any fluid in a well, a well size, volume of compounds to be dispensed remaining in dispense device 100, drop volume range of dispense device 100, etc.

In some examples, the dispense request may be acquired from a display coupled to device 100 displaying, for example, a GUI. In other examples, the dispense request may be acquired from a remote device via any communication protocol. In the following discussion and in the claims, the term “couple” or “couples” is intended to include suitable indirect and/or direct connections. Thus, if a first component is described as being coupled to a second component, that coupling may, for example, be: (1) through a direct electrical or mechanical connection, (2) through an indirect electrical or mechanical connection via other devices and connections, (3) through an optical electrical connection, (4) through a wireless electrical connection, and/or (5) another suitable coupling. In contrast, the term “connect,” “connects,” or “connected” is intended to include direct mechanical and/or electrical connections.

In examples, dispense engine 120 may control the fluid dispense device to dispense at least a portion of a default dilution of a compound according to a dispense routine. In examples, dispense engine 120 may be coupled to the fluid dispense device to dispense fluid into a well plate. In examples, the default dilution of the compound may be received or housed in a chamber of the fluid dispense device. In examples, a well plate may be coupled to the fluid dispense device. In examples, the well plate may be coupled to a transportation mechanism to move or transport the well plate such that a specific well may receive a compound from the fluid dispense device. In other examples, the well plate may remain stationary and the fluid dispense device or a portion thereof, may travel or be transported such that a specific well may receive a compound from the fluid dispense device. In yet further examples, both the well plate and the fluid dispense device may travel or move to allow a well in the well plate to receive a compound from the fluid dispense device.

In examples, the fluid dispense device may dispense/eject a compound(s) from a chamber. In examples, the fluid dispense device may include chamber(s) to receive compound(s) to be ejected/dispensed. In some examples, a chamber of the fluid dispense device may receive a default dilution. In examples, the fluid dispense device may include a fluid die with nozzles formed therein and an ejection chamber. In examples, nozzles may facilitate ejection/dispensation of a compound. Fluid dispense devices may comprise fluid actuators disposed proximate to the nozzles to cause a compound to be ejected/dispensed from a nozzle orifice. In some examples, dispense engine 120 may generate a control pulse to electrically actuate a fluid actuator of the fluid dispense device to thereby dispense the default dilution. Some examples of types of fluid ejectors implemented in fluid dispense devices include thermal ejectors, piezoelectric ejectors, pressure pulse ejectors, acoustic ejectors, syringes, pin transfer tools and/or other such ejectors that may cause fluid to eject/be dispensed from a nozzle. In some examples, the chamber(s) of the fluid dispense device may be removable. For example, the chamber(s) may be part of a component of the fluid dispense device which may be removed, such as pipettes or a cassette. In one such example, the fluid die, nozzle, and ejection chamber of the fluid dispense device may be removable from the fluid dispense device. In examples, fluid dispense devices may be able to dispense compound volumes from approximately 2 pL to approximately 200 pL. In such an example, the fluid dispense devices may dispense or eject a drop with a drop volume between approximately 2 pL and approximately 300 pL per drop.

Turning now to FIG. 2, this figure illustrates a diagram of an example of a fluid device 200. The device 200 may include all features discussed with reference to the examples of FIG. 1. Example device 200 may include a dilution engine 210, a dispense engine 220, and a fluid dispense device 230.

In some examples, device 200 may be a device to control the ejection of compound(s). In some examples, device 200 may control ejection of compound(s) by fluid dispense device 230 coupled thereto to dispense or eject compound(s). Example fluid dispense device 230 may include digital titration devices, pharmaceutical dispensation devices, lab-on-chip devices, fluidic diagnostic circuits, drop-based ejection devices (e.g., a printhead), 3D printing devices, and/or other such devices in which amounts of compounds may be dispensed or ejected. In this example, the fluid dispense device 230 is illustrated in dashed line to indicate that the fluid dispense device 230 may removably couple with device 200. While in this example, the fluid dispense device 230 may removably couple with device 200, other examples may include other configurations. For example, portions of the fluid dispense device 230 may be coupled to device 200, while some portions may be removably coupled therewith. In some examples, device 200 may be a fluid dispense device to dispense or eject a fluid into well plate 50. In such an example, device 200 may include a removable fluid ejector, such as a pipette or a fluid die with nozzles. In examples, well plate 50 may be coupled to device 200 to allow device 200 to dispense a fluid therein.

In examples, dilution engine 210 may determine a dispense routine for a default dilution of a compound according to a dispense request 240 identifying a second dilution of the compound. In examples, dilution engine 210 may determine the dispense routine by comparing the second dilution to the default dilution to determine whether the default dilution may be dilutable to the second dilution. In examples, the default dilution may be identified by a user in device 200. In some examples, the default dilution may be one of a plurality of dilutions available to the fluid dispense device for dispensing/ejecting. For example, a default dilution may be chosen from among two dilutions of a compound available to fluid dispense device 230.

In operation, in an example, device 200 may receive a dispense request 240 identifying a dilution of a compound to be dispensed. In such an example, device 200 may determine whether any dilution of the compound may be available to device 200 to perform dispense request 240. In an example, device 200 may determine none of the dilutions of the compound available to device 200 may be used for dispense request 240. In such an example, device 200 may determine a second dilution of the compound to be used to perform dispense request 240. In such an example, device 200 may request a user provide the second dilution for dispensing via, for example, a display 250 displaying a GUI coupled to device 200. In some example, device 200 may receive a default dilution request identifying a default dilution to use for dispense request 240.

In operation, in another example, device 200 may provide a prompt for a user to identify a default dilution(s) for compound(s) to be used via, for example, display 250. In some examples, the default dilution may be a plurality of dilutions. For example, the default dilution may identify two dilutions of a compound to be used in a dispense routine. In one such example, the default dilution request may identify one of the default dilutions to prioritize over other default dilutions.

In examples, device 200 may passively acquire (i.e., receive) or actively acquire (i.e., retrieve) dispense request 240. In examples, dispense request 240 may be a request to dispense compound(s) from fluid dispense device 200. In examples, dispense request 240 may specify a dilution of a compound to be ejected/dispensed. For example, dispense request 240 may specify to dispense a 1:6 dilution of compound A to compound B in well of well plate 50. In another example, dispense request 240 may specify to dispense a 1:100 dilution of compound A. In examples, dilution engine 210 may determine a dispense routine to be perform to reach the dilution specified in dispense request 240. For example, to dispense a 1:6 dilution of compound A to compound B into a well of well plate 50, dilution engine 210 may determine as a dispense routine a volume of compound A to dispense compared to a volume of compound B to dispense according to a variety of factors. In another example, to dispense a 1:100 dilution of compound A into well plate 50, dilution engine 210 may determine a volume of compound A to dispense according to a variety of factors. In examples, the variety of factors to determine the dispense routine may be a volume of any fluid in a well, a well size, a volume of compounds to be dispensed to remain in dispense device 200, a drop volume range of dispense device 200, etc.

In some examples, the dispense request may be acquired from a GUI displayed on display 250 coupled to device 200. In other examples, the dispense request may be acquired from a remote device via any communication protocol.

In examples, dispense engine 220 may control fluid dispense device 230 to dispense at least a portion of a default dilution of a compound according to a dispense routine. In examples, dispense engine 220 may be coupled to fluid dispense device 230 to dispense compound(s) into well plate 50. In the example of FIG. 2, fluid dispense device 230 may include a chamber 235a, a chamber 235b, and a chamber 235c. In examples, the default dilution of the compound may be received or housed in any of chamber 235a, chamber 235b, and chamber 235c of fluid dispense device 230. In examples, well plate 50 may be coupled to a transportation mechanism to move or transport well plate 50 such that each well of well plate 50 may receive a compound from at least one of chamber 235a, chamber 235b, and chamber 235c. In other examples, well plate 50 may remain stationary and device 200 or a portion thereof, such as fluid dispense device 230 or a portion thereof, may travel or be transported such that each well of well plate 50 may receive a compound from at least one of chamber 235a, chamber 235b, and chamber 235c. In yet further examples, both well plate 50 and device 200 may travel or move to allow each well in well plate 50 to receive a compound from at least one of chamber 235a, chamber 235b, and chamber 235c.

In examples, fluid dispense device 230 may include a fluid die with nozzles formed therein and an ejection chamber. In examples, nozzles may facilitate ejection/dispensation of a compound. Fluid dispense device 230 may comprise fluid actuators disposed proximate to the nozzles to cause drops of a compound to be ejected/dispensed from a nozzle orifice. In some examples, dispense engine 220 may generate a control pulse to electrically actuate a fluid actuator of the fluid dispense device to thereby dispense the default dilution. Some examples of types of fluid ejectors implemented in fluid dispense devices include thermal ejectors, piezoelectric ejectors, pressure pulse ejectors, acoustic ejectors, syringes, pin transfer tools and/or other such ejectors that may cause fluid to eject/be dispensed from a nozzle. In some examples, chamber 235a, chamber 235b, and chamber 235c of fluid dispense device 230 may be removable. In some examples, a compound supply container may include at least one of chamber 235a, chamber 235b, and chamber 235c formed therein. In such an example, the compound supply container may be coupled to fluid dispense device 230. For example, chamber 235a, chamber 235b, and chamber 235c may be part of a component of the fluid dispense device which may be removed, such as pipettes or a cassette. In one such example, the fluid die, nozzle, and ejection chamber of the fluid dispense device may be removable from fluid dispense device 230 along with at least one of chamber 235a, chamber 235b, and chamber 235c. In examples, fluid dispense device 230 may be able to dispense compound volumes from approximately 2 pL to approximately 200 μL. In such an example, fluid dispense device 230 may dispense or eject a drop with a drop volume between approximately 2 pL and approximately 300 pL per drop.

While the example of FIG. 2 illustrates a fluid dispense device 230 with at least three chambers, other examples may include more or less chambers. In some examples, a fluid dispense device may comprise less chambers—i.e., one or two chambers. In other examples, a fluid dispense device may include more than three chambers, such as four chambers, five chambers, and/or other such configurations. Accordingly, example fluid dispense devices and devices with which such fluid dispense devices may couple may include sets of chambers based at least in part on application parameters.

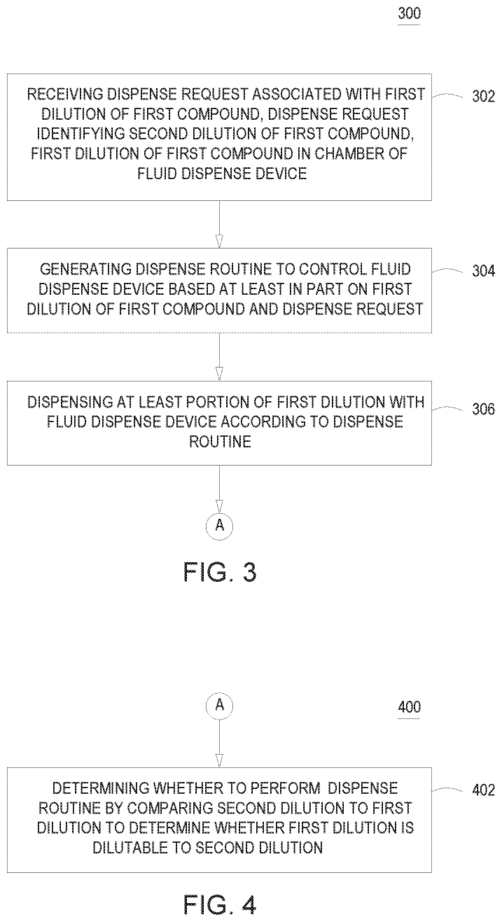

Turning to FIG. 3, this figure provides a flowchart 300 that illustrates a sequence of operations corresponding to a process to dispense a dilution. As shown in 3, with a processor, a dispense request associated with a first dilution of a first compound may be received at block 302. In examples, the dispense request may identify a second dilution of the first compound. In examples, the first dilution of the first compound may be in a chamber of a fluid dispense device. For example, referring to FIG. 2, the first dilution may be in chamber 235a of fluid dispense device 230.

At 304, a dispense routine to control a fluid dispense device may be generated based at least in part on first dilution of first compound and the dispense request. In examples, the dispense routine may identify a chamber from which to dispense. In other examples, the dispense routine may identify a number of drops of the first dilution to eject/dispense from a chamber of the fluid dispense device. In other examples, the dispense routine may identify a drop volume of the first dilution to eject/dispense from a chamber. For example, referring again to FIG. 2, the dispense routine may identify chamber 235a as housing the first dilution, a drop volume, and a number of drops of fluid to eject/dispense from chamber 235a.

At 306, at least a portion of the first dilution is dispensed with the fluid dispense device according to the dispense routine. In examples, dispensing at least a portion of the first dilution with the fluid dispense device comprises generating a control pulse to electrically actuate a fluid actuator of the fluid dispense device to thereby dispense the first dilution. For example, referring again to FIG. 2, at least a portion of a first dilution in chamber 235a may be dispensed based at least in part on a dispense routine.

Turning now to FIG. 4 is a flowchart of example processes which may be incorporated into the flowchart of FIG. 3.

At 402, a device may determine whether to perform the dispense routine by comparing the second dilution to the first dilution to determine whether the first dilution is dilutable to the second dilution.

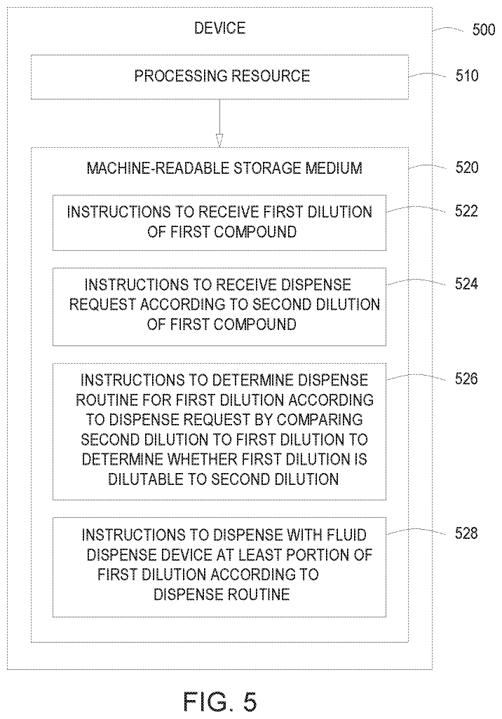

Turning now to FIG. 5, FIG. 5 is a block diagram of an example device 500 to dispense a fluid. In the example of FIG. 5, device 500 includes a processing resource 510 and a machine-readable storage medium 520 comprising (e.g., encoded with) instructions 522, 524, 526, and 528 executable by processing resource 510. In some examples, storage medium 520 may include additional instructions. In some examples, instructions 522, 524, 526, and 528, any other instructions described herein in relation to storage medium 520, may be stored on a machine-readable storage medium remote from but accessible to device 500 and processing resource 510 (e.g., via a computer network). In some examples, instructions 522, 524, 526 and 528 may be instructions of a computer program, computer application (“app”), agent, or the like, of device 500. In other examples, the functionalities described herein in relation to instructions 522, 524, 526, and 528 may be implemented as engines comprising any combination of hardware and programming to implement the functionalities of the engines, as described above.

In the example of FIG. 5, instruction 522 may receive a first dilution of a first compound. In examples, the first dilution may be a default dilution selected by a user.

In instructions 524, device 500 receives a dispense request according to a second dilution of the first compound. In examples, the dispense request may be received via GUI displayed on a display coupled to the dispense device. In other examples, the dispense request may be received from another device via any communication protocol.

In instruction 526, device 500 determines a dispense routine for the first dilution according to the dispense request by comparing the second dilution to the first dilution to determine whether the first dilution is dilutable to the second dilution.

In instruction 528, device 500 dispenses with a fluid dispense device at least a portion of the first dilution according to the dispense routine

In some examples, instructions 522, 524, 526, and 528 may be part of an installation package that, when installed, may be executed by processing resource 510 to implement the functionalities described herein in relation to instructions 522, 524, 526, and 528. In such examples, storage medium 520 may be a portable medium, such as a CD, DVD, flash drive, or a memory maintained by an imaging device from which the installation package can be downloaded and installed. In other examples, instructions 522, 524, 526 and 528 may be part of an application, applications, or component already installed on imaging device 500 including processing resource 510. In such examples, the storage medium 520 may include memory such as a hard drive, solid state drive, or the like. In some examples, the operations of the flowcharts of FIGS. 3-4 may be re-ordered, performed concurrently, or combined. In some examples, functionalities described herein in relation to FIG. 5 may be provided in combination with functionalities described herein in relation to any of FIGS. 1-4. Similarly, any components of the devices shown in FIGS. 1, 2, and 5 may be removed, or combined with other components of other example devices.

What is claimed is:

1. A fluid dispense device, comprising:
a dilution engine to determine a dispense routine for a default dilution of a first compound according to a dispense request identifying a second dilution of the first compound, the dilution engine to determine the dispense routine by comparing the second dilution to the default dilution to determine whether the default dilution is dilutable to the second dilution; and
a dispense engine to control the dispense device to dispense at least a portion of the default dilution of the first compound according to the dispense routine.

2. The device of claim 1, wherein the fluid dispense device is a fluid die with an ejection chamber.

3. The device of claim 1, further comprising:
a chamber to receive the default dilution.

4. The device of claim 3, wherein the chamber is removable from the fluid dispense device.

5. The device of claim 1, wherein the dispense request is received via a graphical user interface (GUI).

6. The device of claim 1, wherein the dispense engine is to generate a control pulse to electrically actuate a fluid actuator of the fluid dispense device to thereby dispense the default dilution.

7. A method for dispensing a dilution, comprising:
receiving, with a processor, a dispense request associated with a first dilution of a first compound, the dispense request identifying a second dilution of the first compound, the first dilution of the first compound in a chamber of a fluid dispense device;
generating a dispense routine to control the fluid dispense device based at least in part on the first dilution of the first compound and the dispense request; and
dispensing at least a portion of the first dilution with the fluid dispense device according to the dispense routine.

8. The method of claim 7, further comprising:
determining whether to perform the dispense routine by comparing the second dilution to the first dilution to determine whether the first dilution is dilutable to the second dilution.

9. The method of claim 8, wherein generating the dispense routine to control the fluid dispense device is based at least in part on determining whether to perform the dispensing routine.

10. The method of claim 7, wherein the dispense request is received via a graphical user interface (GUI).

11. The method of claim 7, wherein the dispensing at least a portion of the first dilution with the fluid dispense device comprises generating a control pulse to electrically actuate a fluid actuator of the fluid dispense device to thereby dispense the first dilution.

12. The method of claim 7, wherein the fluid dispense device comprises a pipette having the chamber therein.

13. The method of claim 7, wherein the chamber is removable from the fluid dispense device.

14. A non-transitory machine-readable storage medium comprising instructions executable by a processing resource to:
receive a first dilution of a first compound;
receive a dispense request according to a second dilution of the first compound;
determine a dispense routine for the first dilution according to the dispense request by comparing the second dilution to the first dilution to determine whether the first dilution is dilutable to the second dilution;
dispense with a fluid dispensing device at least a portion of the first dilution according to the dispense routine.

15. The medium of claim 14, wherein to dispense at least a portion of the first dilution with the fluid dispense device comprises generating a control pulse to electrically actuate a fluid actuator of the fluid dispense device to thereby dispense the first dilution.
